(19) United States
(12) Patent Application Publication
(10) Pub. No.: US 2024/0034598 A1
(43) Pub. Date: Feb. 1, 2024

(54) HANGING FITTING

(71) Applicant: Kito Corporation, Yamanashi (JP)

(72) Inventor: Rika SUZUKI, Yamanashi (JP)

(73) Assignee: Kito Corporation, Yamanashi (JP)

(21) Appl. No.: 18/265,973

(22) PCT Filed: Nov. 25, 2021
(86) PCT No.: PCT/JP2021/043220

§ 371 Date: Jun. 8, 2023

(30) Foreign Application Priority Data
Dec. 15, 2020 (JP) 2020-207773

(51) Int. Cl. B66C 1/66

(52) U.S. Cl. CPC B66C 1/66

(57) ABSTRACT

A hanging fitting is fixed to a mounting surface of a cargo. The hanging fitting comprises: a rotary coupling member which rotates around a direction orthogonal to the mounting surface of the cargo; and an anchor fitting which has a male threaded part to be screwed into the mounting surface of the cargo, and pivotally supports the rotary coupling member. The rotary coupling member comprises: a main body part; an arched beam part provided at an upper part of the main body part; and an opening part formed by providing the beam part. At least a part of at least either one side surface of two side surfaces provided at both end portions in a width direction of the beam part has a shape projecting outward at a midpoint of the beam part in an extending direction or at a position shifted by a predetermined amount from the midpoint.

### TECHNICAL FIELD

The present invention relates to a hanging fitting used when performing a cargo lifting work, a cargo pulling-up work, a reversing work, and so on.

### BACKGROUND ART

Conventionally, an eyebolt (hanging fitting) is used as a fitting to be mounted on a cargo when performing the cargo lifting work, the cargo pulling-up, the reversing work, and so on. The hanging fitting is used in a state where a male threaded portion is screwed into a female threaded portion of the cargo and fastened to a mounting surface of the cargo. If the orientation of a load acting on the eyebolt in the above work is wrong, it rotates in a direction in which the fastening of the screw is loosened, and if it is continued to be used in that state, the screw may fall out or the threaded portion may be folded or broken, which is dangerous.

In recent years, there provided are various universal hanging fittings such as a hanging fitting including a holding part rotating 3600 around an axial direction of the threaded portion and a shackle pivotally and swingably supported by the holding part, a hanging fitting having a rotary coupling member rotating 3600 around an axis of the threaded portion and an elliptical link engaged with the rotary coupling member, and so on. These universal hanging fittings can prevent the occurrence of the above event because the holding part and the rotary coupling member turn around the threaded portion fastened to the cargo as a rotation center and the threaded portion is never loosened.

For example, in the case of the hanging fitting having the rotary coupling member rotating 3600 around the axis of the threaded portion and the link to be engaged with the rotary coupling member, the link mounted on the rotary coupling member has a structure capable of not only swing with respect to the rotary coupling member but also moving along the shape of the link. Therefore, the hanging fitting sometimes lifts the cargo in a state where the link is not suitable to lift the cargo, and when lifting the cargo, an excessive load acts on the hanging fitting, which is dangerous.

There is also provided a hanging fitting capable of correcting the mutual states (postures) of an annular link and a rotary coupling member to states suitable to lift the cargo in the process of lifting the cargo (refer to Patent Literature 1). This hanging fitting has a structure that an opening part of the rotary coupling member is arranged such that the position of the center of the opening part is shifted by a predetermined amount from an axial direction of the threaded portion, and the width of an annular part is formed to be narrower toward the direction in which the opening part is shifted in plan view of the hanging fitting. By using of the structure, the rotary coupling member rotates around the axial direction of the threaded portion while the link is being moved to one end side where the width of the rotary coupling member becomes narrower in the process of lifting the cargo. By performing these operations, the mutual states of the annular link and the rotary coupling member are corrected to the states suitable to lift the cargo.

### CITATION LIST

### Patent Literature

{PTL 1} WO 2014/029385A

### SUMMARY OF INVENTION

### Technical Problem

However, in the case of the above universal hanging fitting, in the case of correcting the mutual states of the annular link and the rotary coupling member to the states suitable to lift the cargo, the annular link is moved at all times to the one end side where the width of the rotary coupling member becomes narrower. In other words, the rotary coupling member is likely to wear only at one end side due to friction with the link, and the service life of the hanging fitting itself is possibly shortened. Further, the center position of the opening part is arranged shifted by the predetermined amount from the axis of the threaded portion, so that an eccentric load undesirably acts thereon.

The present invention has been made in consideration of the problem and its object is to provide a hanging fitting capable of preventing shortening of a service life due to wear of a rotary coupling member only at one side in a structure of correcting mutual states of an annular link and a rotary coupling member in a lifting direction in a process of lifting a cargo.

### Solution to Problem

To solve the above problem, an aspect of the hanging fitting is a hanging fitting to be fixed to a mounting surface of a cargo and used in a hanging work of the cargo, the hanging fitting including: a rotary coupling member which rotates around a direction orthogonal to the mounting surface of the cargo; and an anchor fitting which has a male threaded part to be screwed into a female threaded portion provided at the mounting surface of the cargo, and pivotally supports the rotary coupling member, the rotary coupling member including: a main body part; an arched beam part provided at an upper part of the main body part; and an opening part formed by providing the beam part at a top of the main body part, at least a part of at least either one side surface of two side surfaces provided at both end portions in a width direction of the beam part having a shape projecting outward at a midpoint of the beam part in an extending direction of the beam part or at a position shifted by a predetermined amount from the midpoint from the extending direction in plan view of the rotary coupling member.

Further, the side surface is constructed by joining at least two flat surfaces folded outward, and a vertex of the side surface is arranged on a straight line passing through the midpoint in the extending direction of the beam part and extending in a direction orthogonal to the extending direction of the beam part, in plan view of the rotary coupling member.

Further, the side surface is constructed by joining at least two flat surfaces folded outward, and a vertex of the side surface is arranged at a position shifted by a predetermined amount to either one end portion side of both end portions of the beam part from the midpoint in the extending direction of the beam part, in plan view of the rotary coupling member.

Further, the opening part is provided such that a center axis of the opening part is orthogonal to a rotation axis of the rotary coupling member

Further, a link to be engaged with the rotary coupling member is inserted into the opening part.

Note that it is preferable that: the link is made by bending a bar member into an elliptical shape having two semicircular arc parts and two straight parts linking the two semicircular arc parts; and a diameter of the opening part is larger than a diameter of the bar member and smaller than a maximum radius of the two semicircular arc parts provided at the link.

Further, the anchor fitting has a fitting coupling part which rotatably couples the rotary coupling member, and an outer shape of an upper surface of the fitting coupling part is larger than an outer shape of a lower surface of the main body part.

### Advantageous Effects of Invention

According to the present invention, it is possible to prevent shortening of a service life due to wear of a rotary coupling member at only one side in a structure of correcting a posture of a link with respect to an anchor fitting in a process of lifting a cargo.

### BRIEF DESCRIPTION OF DRAWINGS

FIG. 1 is a perspective view illustrating an example of a hanging fitting in this embodiment.

FIG. 2 is an exploded perspective view illustrating the hanging fitting illustrated in FIG. 1.

FIG. 3 is a perspective view illustrating an example of a structure of a rotary coupling member.

FIG. 4(a) is a plan view explaining a configuration of a side surface of a beam part of the rotary coupling member, and FIG. 4(b) is a plan view explaining a width of the beam part of the rotary coupling member.

FIG. 4(a) is a cross-sectional view taken along I-I illustrated in FIG. 4(b), and FIG. 5(b) is a cross-sectional view taken along II-II illustrated in FIG. 5(a).

FIG. 5(a) is a perspective view illustrating an example of the hanging fitting with a link being held in a state where a semicircular arc part of the link is inserted into an opening part of the rotary coupling member, and FIG. 5(b) is a perspective view illustrating an example of the hanging fitting with a link being held in a state where a straight part of the link is inserted into the opening part of the rotary coupling member.

FIG. 7(a) is a perspective view illustrating an example of the hanging fitting in the case where a force H in a z-direction acts on the link in a state where the semicircular arc part of the link is inserted into the opening part of the rotary coupling member, and FIG. 7(b) is a cross-sectional view illustrating a state of the link and the rotary coupling member of the hanging fitting illustrated in FIG. 7(a).

FIG. 8 is a perspective view illustrating an example of the hanging fitting in the case where the force H in the z-direction does not act on the link any longer.

FIG. 9(a) is a perspective view illustrating an example of the hanging fitting in the case where a force J in an x-direction acts on the link in a state where the straight part of the link is inserted into the opening part of the rotary coupling member, FIG. 9(b) is a cross-sectional view illustrating a state of the link and the rotary coupling member of the hanging fitting illustrated in FIG. 9(a), and FIG. 9(c) is a plan view of the hanging fitting illustrated in FIG. 9(a).

FIG. 10 is a perspective view illustrating an example of the hanging fitting in the case where the force J in the x-direction does not act on the link any longer.

FIG. 11 is a cross-sectional view illustrating a state of the link and the rotary coupling member of the hanging fitting in the case where a force K acts obliquely upward on the link in FIG. 9(a).

FIG. 12(a) is a plan view explaining a configuration in another embodiment of the side surface of the beam part of the rotary coupling member, and FIG. 12(b) is a plan view explaining a width of the beam part of the rotary coupling member.

FIG. 13(a) is a cross-sectional view taken along III-III illustrated in FIG. 12(b), and FIG. 5(b) is a cross-sectional view taken along IV-IV illustrated in FIG. 13(a).

FIG. 14(a) is a plan view of the hanging fitting, and FIG. 14(b) is a cross-sectional view illustrating a state of the link and the rotary coupling member of the hanging fitting illustrated in FIG. 14(a).

FIG. 15(a) is a perspective view illustrating another embodiment of the hanging fitting, and FIG. 15(b) is a side view of the hanging fitting illustrated in FIG. 15(a).

### DESCRIPTION OF EMBODIMENTS

Hereinafter, an embodiment of a hanging fitting in this embodiment will be explained with reference to the drawings. Note that in this embodiment, a width of a later-explained arched beam part 37 is regarded as an x-direction, a direction linking both ends of the arched beam part 37 (length direction of the beam part 37) is regarded as a y-direction, and a thickness (height) direction of the arched beam part 37 is regarded as a z-direction. Note that an axial direction of a later-explained male threaded part 21 coincides with the z-direction.

A hanging fitting 10 explained in this embodiment is a kind of so-called hanging fitting, and fixed to a mounting surface of a cargo and used when performing a cargo lifting work, pulling-up work, reversing work, and so on.

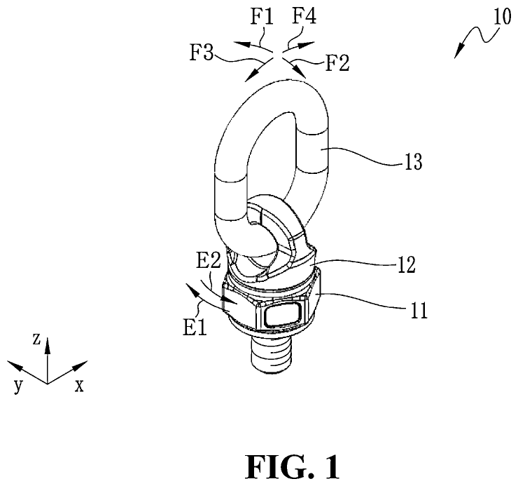

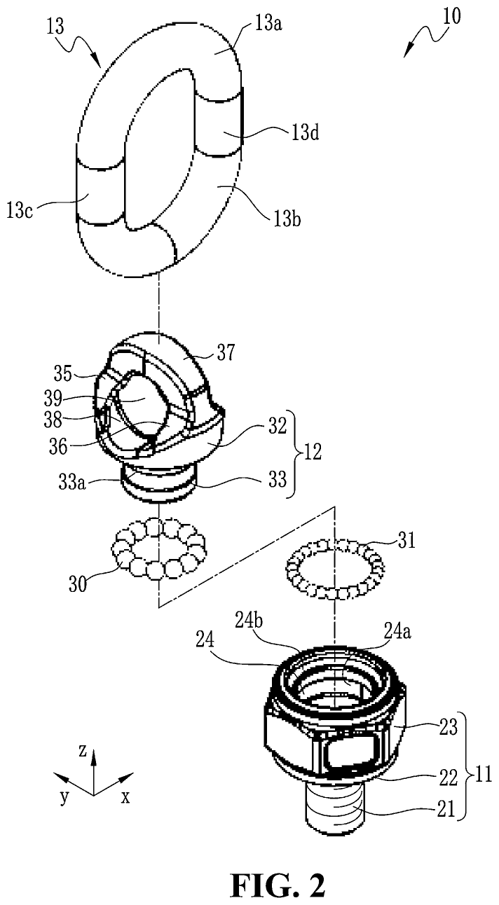

As illustrated in FIG. 1 and FIG. 2, the hanging fitting 10 has an anchor fitting 11, a rotary coupling member 12, and a link 13.

The anchor fitting 11 is a portion to be mounted on a not-illustrated cargo, and the anchor fitting 11 in this embodiment is provided in a shape of an almost hexagon head bolt having a recess formed at the head portion. The anchor fitting 11 has the male threaded part 21, an anchor seat part 22, and a fitting coupling part 23.

The male threaded part 21 is extended from a lower surface of the fitting coupling part 23 in a direction (z-direction) orthogonal to the lower surface, opposite to and having an axial center aligned with that of a later-explained insertion space 24 of the fitting coupling part 23. The male threaded part 21 is a shaft-shaped portion formed with a male thread on its outer peripheral surface. The male threaded part 21 is screwed into a female thread provided in a mounting hole of the cargo. This fixes the anchor fitting 11 to the cargo.

The anchor seat part 22 is integrated with the fitting coupling part 23 on a lower end side of the fitting coupling part 23. When the hanging fitting 10 is fixed to a mounting surface (not illustrated) of the cargo, the anchor seat part 22 is brought into contact with the mounting surface of the cargo to prevent the generation of a gap between the anchor fitting 11 and the cargo. The anchor seat part 22 may be provided in a circular ring shape around the male threaded part 21 or may be provided in a disk shape, at the lower end portion of the fitting coupling part 23.

The fitting coupling part 23 is a member corresponding to a head portion of a bolt which is easily operated with a tool. In short, the fitting coupling part 23 has a shape (for example, hexagonal prismatic shape) fittable with the tool such as a wrench.

Therefore, fitting the fitting coupling part 23 with the tool makes it easy to screw the male threaded part 21 to the female thread of the cargo, thereby improving the workability when fastening the anchor fitting 11.

The fitting coupling part 23 is a portion coupled with the rotary coupling member 12. The fitting coupling part 23 has the insertion space 24 with an upper surface open. Into the insertion space 24, a rotary shaft part 33 of the rotary coupling member 12 is inserted.

An inner peripheral surface facing the insertion space 24 is formed with a recessed part 24a having a cross section in almost semicircular shape over the entire circumference. When the rotary shaft part 33 of the rotary coupling member 12 is inserted into the insertion space 24, the recessed part 24a faces a recessed part 33a provided at the rotary shaft part 33 of the rotary coupling member 12 to form a doughnut-shaped passage (not illustrated). In the doughnut-shaped passage, a plurality of bearing balls 30 are arranged. Arranging the plurality of bearing balls 30 in the passage makes it possible to smoothly rotate the rotary coupling member 12 with respect to the fitting coupling part 23.

Note that though not illustrated, the plurality of bearing balls 30 are inserted into the doughnut-shaped passage from a female threaded hole (not illustrated) provided at the fitting coupling part 23 with the rotary shaft part 33 of the rotary coupling member 12 inserted into the insertion space 24 of the anchor fitting 11. By inserting the plurality of bearing balls 30 to the inside of the doughnut-shaped passage from the female threaded hole, the anchor fitting 11 and the rotary coupling member 12 are coupled with each other and the rotary coupling member 12 is brought into a state of being pivotally supported by the anchor fitting 11. Note that the female threaded hole is sealed with a screw rod with a hexagonal hole. As a result of this, it is possible to prevent the bearing ball 30 from getting out of the female threaded hole.

The fitting coupling part 23 has a stepped part 24b continuing to the insertion space 24, at an upper end portion of the insertion space 24. At the stepped part 24b, a plurality of bearing balls 31 are arranged over the entire circumference. When the rotary shaft part 33 of the rotary coupling member 12 is inserted into the insertion space 24 of the fitting coupling part 23, the plurality of bearing balls 31 arranged at the stepped part 24b are held between the stepped part 24b and the rotary coupling member 12. By holding the plurality of bearing balls 31 between the stepped part 24b of the fitting coupling part 23 and the rotary coupling member 12, the rotary coupling member 12 rotatably supports a radial load and a thrust load acting thereon, while sharing the loads with the plurality of bearing balls 31.

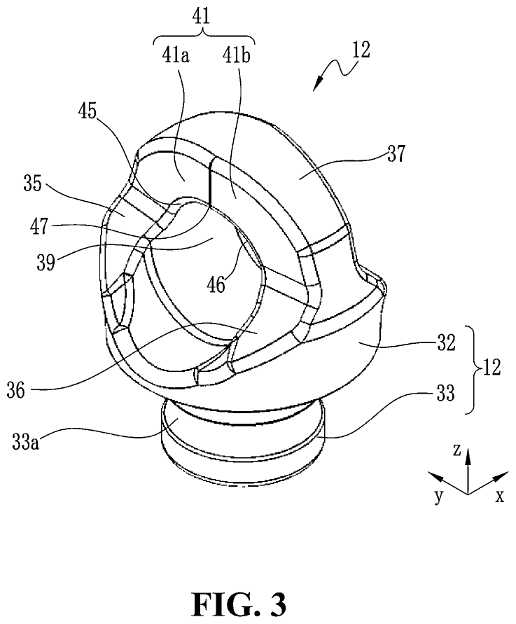

The rotary coupling member 12 is a member with which the link 13 is engaged. The rotary coupling member 12 is rotatable in an E1 direction or an E2 direction in FIG. 1 (circumferential direction of the rotary shaft part 33) with respect to the anchor fitting 11. As illustrated in FIG. 3, the rotary coupling member 12 has a main body part 32 and the rotary shaft part 33. The main body part 32 has, for example, two raised parts 35, 36 provided at an interval of 180° on an upper surface of the disk-shaped main body part 32 in plan view of the rotary coupling member 12, and the arched beam part 37 arranged across the two raised parts 35, 36. By arranging the beam part 37 across the two raised parts 35, 36, the beam part 37 and the two raised parts 35, 36 form an annular portion on the upper surface of the main body part 32. Further, the beam part 37 and the two raised parts 35, 36 form the annular portion, whereby the main body part 32 has an opening part 39 surrounded by them. The rotary coupling member 12 has been subjected to R chamfering at a boundary portion between two continuing surfaces.

Between the two raised parts 35, 36, a recessed part (groove portion) 38 is provided in a direction orthogonal to the extending direction of the beam part 37. The recessed part 38 is provided continuously to the opening part 39 provided below the beam part 37. Note that the raised parts 35, 36 have upper surfaces being upward inclined surfaces toward side surfaces 41, 42 of the beam part 37, respectively.

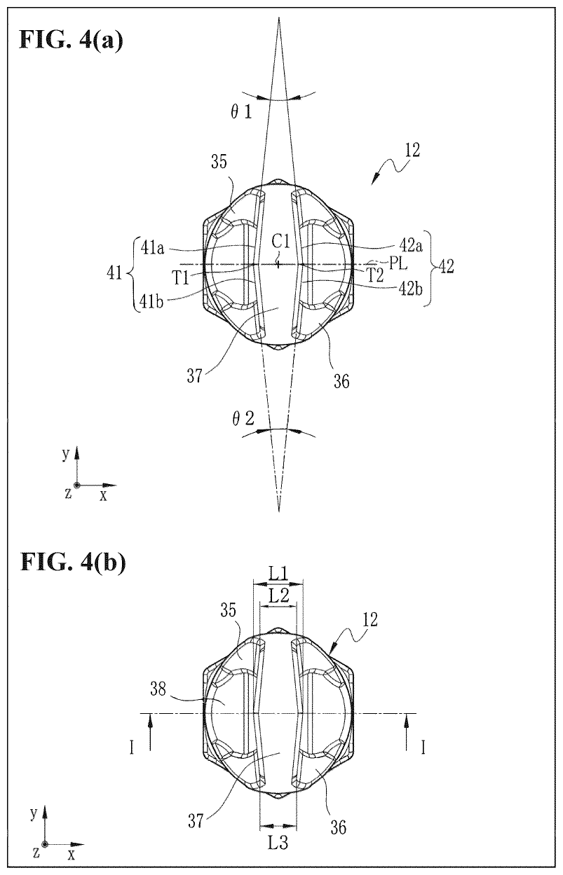

As illustrated in FIG. 4(a), the beam part 37 has the side surfaces 41, 42 at both end portions in the x-direction in FIG. 4(a). One side surface 41 has such a shape that two flat surfaces 41a, 41b are joined while being folded into a projecting shape toward an outer peripheral edge (outward) of the main body part 32 in plan view of the hanging fitting 10. Similarly, the other side surface 42 of the beam part 37 has such a shape that two flat surfaces 42a, 42b are joined while being folded into a projecting shape toward an outer peripheral edge (outward) of the main body part 32 in plan view of the hanging fitting 10. Here, a vertex T1 of the side surface 41 and a vertex T2 of the side surface 42 are located at a midpoint in the extending direction of the beam part 37 (y-direction in FIG. 4(a)). More specifically, the vertex T1 of the side surface 41 and the vertex T2 of the side surface 42 are arranged on a plane PL orthogonal to the extending direction of the beam part 37 and including a rotation axis (axial center) C1 of the rotary shaft part 33 of the rotary coupling member 12. Note that though the side surface 41 and the side surface 42 of the beam part 37 each have such a shape that the two flat surfaces are joined while being folded into the projecting shape toward the outer peripheral edge (outward) of the main body part 32 in this embodiment, the flat surface of at least one of the side surface 41 and the side surface 42 of the beam part 37 may have such a shape that the two flat surfaces are joined while being folded into the projecting shape toward the outer peripheral edge (outward) of the main body part 32.

On the two side surface 41 and side surface 42, an angle θ1 formed between the flat surface 41a of the side surface 41 and the flat surface 42a of the side surface 42 on an xy-plane and an angle θ2 formed between the flat surface 41b of the side surface 41 and the flat surface 42b of the side surface 42 on the xy-plane are the same and acute angles. In other words, as illustrated in FIG. 4(b), a width L1 of the beam part 37 at a middle portion in the x-direction in FIG. 4(b) is larger than widths at both end portions L2, L3 (L2=L3) in plan view of the hanging fitting 10.

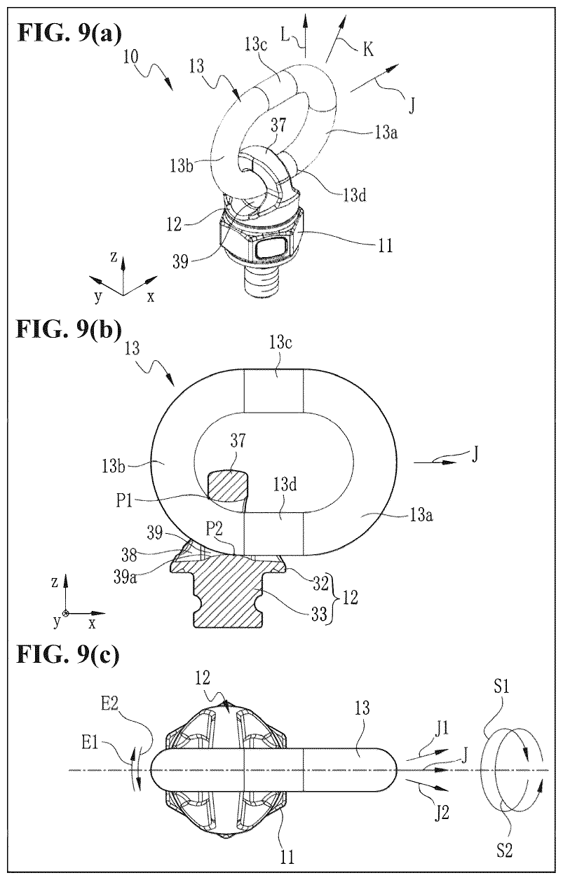

Note that the above angle θ1 and angle θ2 are set as follows. For example, if the above angle θ1 and angle θ2 are increased, when the link 13 moves to either one end portion of both end portions in the extending direction of the beam part 37, a movement amount of the link 13 decreases and the link 13 is likely to bite into a gap generated between the beam part 37 and the raised part (either the raised part 35 or the raised part 36) of the rotary coupling member 12 located on the side to which the link 13 moves. As a result of this, the rotary coupling member 12 does not rotate to a state where the posture of the link 13 with respect to the rotary coupling member 12 stabilizes (see later-explained FIG. 10), but possibly stops rotating in the middle of the rotation. In this event, the posture of the link 13 with respect to the rotary coupling member 12 is unstable, and when a force different from a force acting in a direction in which the cargo is hung on the hanging fitting 10 acts to eliminate the bite of the link 13 into the gap, the rotary coupling member 12 rotates to a state where the posture of the link 13 with respect to the rotary coupling member 12 stabilizes, which is dangerous.

On the other hand, if the angle θ1 and angle θ2 are too small, a force acting when moving the link 13 to either one end portion of both end portions in the extending direction of the beam part 37 is small, and when the posture of the link 13 with respect to the rotary coupling member 12 is brought into a stabilized state (see later-explained FIG. 10), it is necessary to pull the link 13 by a large force more than necessary to rotate the rotary coupling member 12.

Accordingly, in consideration of the movement amount of the link 13 when the link 13 moves to either one end portion of both end portions in the extending direction of the beam part 37 and the securement of a force acting when moving the link 13 to either one end portion of both end portions in the extending direction of the beam part 37, the angle θ1 and the angle θ2 are preferably in a range of, for example, 5 to 25°, and preferably in a range of, for example, 10 to 15°.

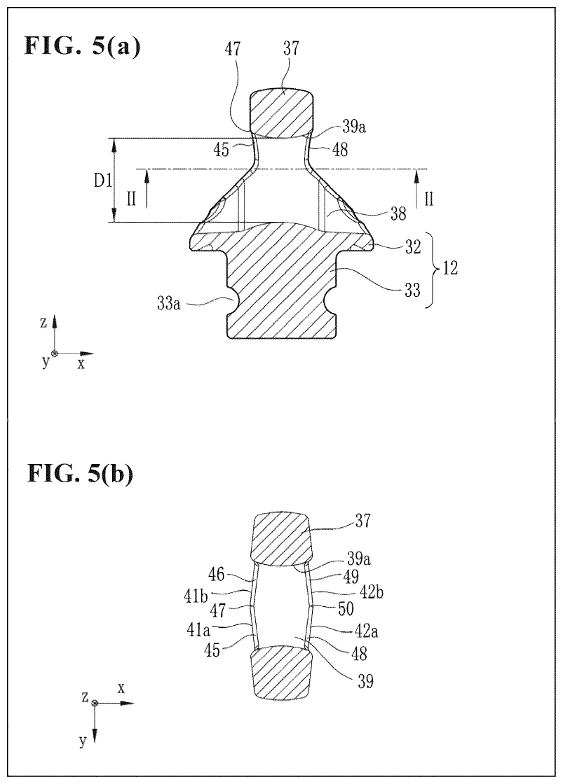

As explained above, the beam part 37 is subjected to R chamfering. Accordingly, as illustrated in FIG. 5(a) and FIG. 5(b), a curved surface 45 is formed between the flat surface 41a of the beam part 37 and an inner peripheral surface 39a of the opening part 39. Further, a curved surface 46 is formed between the flat surface 41b of the beam part 37 and the inner peripheral surface 39a of the opening part 39. Between the curved surfaces 45 and 46, a curved surface 47 is formed which continues to the curved surfaces 45, 46.

Similarly, a curved surface 48 is formed between the flat surface 42a of the beam part 37 and the inner peripheral surface (in other words, the lower surface of the beam part 37) 39a of the opening part 39. Further, a curved surface 49 is formed between the flat surface 42b of the beam part 37 and the inner peripheral surface 39a of the opening part 39. Between the curved surfaces 48 and 49, a curved surface 50 is formed which continues to the curved surfaces 48, 49.

Accompanying that the width L1 of the beam part 37 at the middle portion in the x-direction in FIG. 4(b) is wider than widths of both end portions L2, L3 (L2=L3), an interval between the curved surface 46 and the curved surface 48 and an interval between the curved surface 47 and the curved surface 49 are made such that the interval at both end portions are narrower than the interval at the middle portion of the beam part 37.

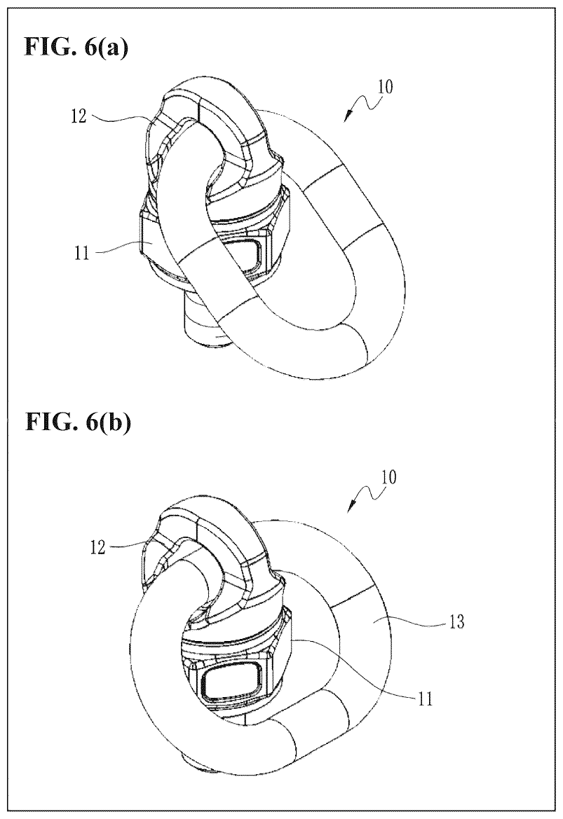

The opening part 39 extends penetrating in a direction (x-direction in FIG. 5(a)) orthogonal to the extending direction (y-direction in FIG. 3) of the beam part 37 and to the axial center C1 of the rotary shaft part 33, as an axial direction. Though not illustrated, the opening part 39 has an opening part cross section in a circular shape, and the opening part 39 is provided at the main body part 32 such that its enter axis is orthogonal to the axial center (axis along the z-direction) of the rotary shaft part 33 being the rotation center of the rotary coupling member 12. The inner peripheral surface 39a of the opening part 39 is a curved surface (arc surface) having a middle portion in the axial direction of the opening part 39 projecting toward the center of the opening part 39. A radius R of the projecting curved surface (arc surface) 39a is, for example, the same as a minimum bending radius R1 of semicircular arc parts 13a, 13b of the link 13. Further, a minimum value D1 (see FIG. 5(a)) of the diameter of the opening part 39 is set, for example, to be larger than a diameter D2 (see FIG. 7(b)) of a bar member constituting the link 13 and to be smaller than about 1.5 times the diameter D2. Note that the minimum value D1 of the diameter of the opening part 39 only needs to be equal to or smaller than a maximum bending radius R2 of the semicircular arc parts 13a, 13b of the link 13. Here, the cross section of the rotary coupling member 12 is illustrated in FIG. 7(b), in which the illustration of hatching indicating the cross section is omitted to eliminate the complexity for convenience of the explanation of the drawing.

Note that the radius R of the inner peripheral surface 39a is, for example, the same as the minimum radius of the semicircular arc parts 13a, 13b of the link 13, but the radius of the inner peripheral surface 39a may be, for example, smaller than the minimum radius R1 of the semicircular arc parts 13a, 13b of the link 13.

As illustrated in FIG. 3, the rotary shaft part 33 provided at the rotary coupling member 12 is extended from a lower portion of the main body part 32 in the vertical direction (−z-direction in FIG. 4). The rotary shaft part 33 is inserted into the insertion space 24 of the fitting coupling part 23 of the anchor fitting 11 and thereby pivotally supported by the anchor fitting 11. The rotary shaft part 33 has on the outer peripheral surface the recessed part 33a having a cross section in an arc shape. When the rotary shaft part 33 is inserted into the insertion space 24 of the fitting coupling part 23 of the anchor fitting 11, the recessed part 33a faces the recessed part 24a provided at the inner peripheral surface facing the insertion space 24 to form the doughnut-shaped passage where the bearing balls 30 are arranged.

Returning to FIG. 1 or FIG. 2, the link 13 is engaged with a hook of a crane, a shackle coupled to the hook of the crane, or the like when performing, for example, the cargo lifting work, pulling-up work, and reversing work.

The link 13 is a member in an elliptical shape having, for example, the two semicircular arc parts 13a, 13b and two straight parts 13c, 13d linking the semicircular arc parts 13a, 13b. Here, the diameters of the semicircular arc part 13a and the semicircular arc part 13b are the same. Accordingly, the two straight part 13c and straight part 13d are parallel. Note that the shape of the link 13 only needs to be an endless shape and therefore is not limited to the elliptical shape. Further, the link 13 is not limited to a metal ring but may be a loop of a wire rope, a stud-link, or the like.

As explained above, the link 13 is held in a state of being coupled with the rotary coupling member 12. The link 13 turns in an F1 direction or an F2 direction in FIG. 1 around a portion inserted into the opening part 39 of the rotary coupling member 12. The link 13 further turns in an F3 direction or an F4 direction on a plane (xz-plane in FIG. 1) including a line linking centers on cross sections orthogonal to the extending direction of the link 13.

Accordingly, when not in use of the hanging fitting 10 or in a state where no force acts on the link 13, the link 13 is held in a state where the link 13 is turned by a predetermined angle in the F2 direction in FIG. 1 with either the semicircular arc part 13a or the semicircular arc part 13b of the link 13 being inserted into the opening part 39 of the rotary coupling member 12 as illustrated in FIG. 6(a), or in a state where the link 13 is turned by a predetermined amount in the F2 direction in FIG. 1 with either the straight part 13c or the straight part 13d of the link 13 being inserted into the opening part 39 of the rotary coupling member 12 as illustrated in FIG. 6(b).

Note that FIG. 6(a) and FIG. 6(b) illustrate examples, and the posture of the link 13 when not in the use of the hanging fitting 10 and in the state where no force acts on the link 13 is not limited to those in FIG. 6(a) and FIG. 6(b). Further, FIG. 6(a) and FIG. 6(b) illustrate the case where the hanging fitting 10 is mounted on the upper surface of the cargo, but even in the case where the hanging fitting 10 is mounted on a side surface of the cargo, the link 13 is held, as a matter of course, in the state where the link 13 is turned by the predetermined angle in the F2 direction in FIG. 1 with either the semicircular arc part 13a or the semicircular arc part 13b of the link 13 being inserted into the opening part 39 of the rotary coupling member 12, or in the state where the link 13 is turned by the predetermined amount in the F2 direction in FIG. 1 with either the straight part 13c or the straight part 13d of the link 13 being inserted into the opening part 39 of the rotary coupling member 12.

Next, the operation of the hanging fitting 10 in this embodiment will be explained.

First, a case where a force H in a z-direction in FIG. 7 acts on the semicircular arc part 13a of the link 13 in the state where the semicircular arc part 13b of the link 13 is inserted into the opening part 39 of the rotary coupling member 12 and the state where the extending directions of the straight parts 13c, 13d of the link 13 are parallel to the z-direction as illustrated in FIG. 7(a) will be explained.

When the force H in the z-direction in FIG. 7 acts on the link 13, the link 13 is brought into contact with a peripheral surface portion, serving as a lower surface of the beam part 37, of the inner peripheral surface 39a of the opening part 39 as illustrated in FIG. 7(b), and pulls upward the rotary coupling member 12. Note that the inner peripheral surface 39a of the opening part 39 is the same as the minimum bending radius R1 of the semicircular arc parts 13a, 13b of the link 13. Accordingly, the link 13 is brought into a state where the semicircular arc part 13b is in line contact with a portion, located on the lower surface of the beam part 37, of the inner peripheral surface 39a of the opening part 39. In this state, the posture of the link 13 with respect to the rotary coupling member 12 is stable.

In this event, when either a force F1 for rotation around the z-direction in FIG. 7(a) (hereinafter, rotational force) or a rotational force F2 acts on the link 13, the link 13 rotates in a direction in which either the rotational force F1 or the rotational force F2 acts. By the rotation of the link 13, the semicircular arc part 13b of the link 13 presses the inner peripheral surface 39a of the opening part 39 of the rotary coupling member 12. Accordingly, the rotary coupling member 12 rotates in a predetermined direction (an E1 direction or an E2 direction in FIG. 7(a)).

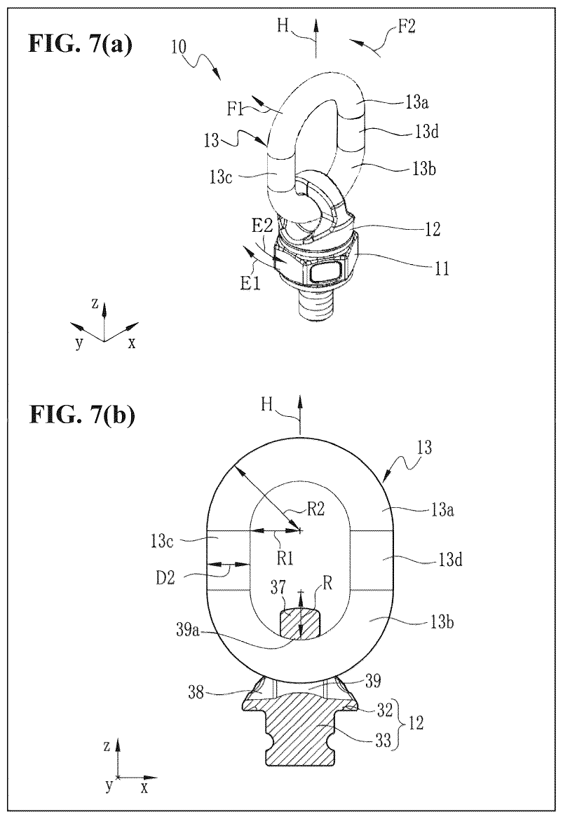

Thereafter, when either the rotational force F1 or the rotational force F2 of the link 13 does not act any longer, the rotation of the link 13 is stopped, and the rotation of the rotary coupling member 12 is also stopped at the same time. Note that FIG. 8 illustrates a state after the rotational force F1 acts on the link 13 and the link 13 and the rotary coupling member 12 rotate 90°.

In the above explanation, the case where the rotational force F1 acts on the link 13 in a process of the force H in the z-direction acting on the link 13 is explained, and this also applies to a case where the rotational force F2 acts on the link 13.

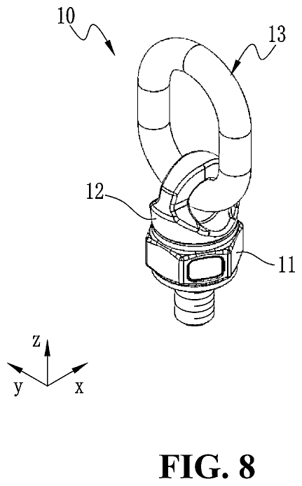

On the other hand, as illustrated in FIG. 9(a), a force J in an x-direction in FIG. 9(c) sometimes acts on the semicircular arc part 13a of the link 13 in a state where the straight part 13d of the link 13 is inserted into the opening part 39 of the rotary coupling member 12, in other words, in a state where a longitudinal direction of the link 13 is orthogonal to the rotation axis direction of the rotary coupling member 12. In this case, the semicircular arc part 13b of the link 13 comes into contact with the curved surface 47 provided at the lower surface of the beam part 37 and with the inner peripheral surface 39a of the opening part 39 (points P1, P2 in FIG. 9(b)). In this state, the link 13 is in contact with the rotary coupling member 12 at two points P1, P2, and therefore the link 13 takes an unstable posture.

If even a small force in a y-direction or a −y-direction in FIG. 9(c) acts on the link 13 in a process of the force J acting in the x-direction in FIG. 9(c), the link 13 is shifted in the direction in which the force acts, and the position where the link 13 and the rotary coupling member 12 are in contact shifts. As a result, the rotary coupling member 12 is rotated in the E1 direction or the E2 direction in FIG. 9(c). When the rotary coupling member 12 is rotated, the link 13 slides along either the curved surface 45 or the curved surface 47 of the beam part 37. In this event, the link 13 rotates with the longitudinal direction of the link 13 as the axial direction. More specifically, the link 13 rotates with the longitudinal direction of the link 13 as the axis according to the rotation of the rotary coupling member 12 in the E1 direction or the E2 direction in FIG. 9(c).

Then, once the longitudinal direction of the link 13 and the extending direction of the beam part 37 of the rotary coupling member 12 become parallel, the link 13 comes into line contact with the inner peripheral surface 39a of the opening part 39 of the rotary coupling member 12, resulting in that the posture of the link 13 with respect to the rotary coupling member 12 stabilizes (see FIG. 10).

Further, the above also applies to a case where a force J1 or a force J2 inclined at a predetermined angle with respect to the x-direction in FIG. 9(c) acts on the semicircular arc part 13a of the link 13. For example, when the force J1 acts on the link 13, the link 13 moves in a direction in which the force J1 acts. Accordingly, the link 13 changes from the state where the semicircular arc part 13b is in contact with the curved surface 47 provided on the lower surface of the beam part 37 to a state where the semicircular arc part 13b is in contact with the curved surface 45. As a result, the rotary coupling member 12 rotates in the E1 direction and the position where the semicircular arc part 13b of the link 13 comes into contact with the curved surface 45 moves in the outer peripheral direction of the rotary coupling member 12. In this process, the link 13 rotates in an S1 direction. When the rotation of the link 13 in the S1 direction, the rotary coupling member 12 also rotates in the E1 direction. Then, once the rotary coupling member 12 rotates, for example, 90°, the link 13 comes into line contact with the inner peripheral surface 39a of the opening part 39 of the rotary coupling member 12. In this event, the posture of the link 13 with respect to the rotary coupling member 12 stabilizes, whereby the rotation of the rotary coupling member 12 and the link 13 stops.

On the other hand, when the force J2 acts on the link 13, the link 13 rotates in an S2 direction. Also in this case, when the rotation of the link 13 in the S2 direction, the rotary coupling member 12 also rotates in the E2 direction. Then, once the rotary coupling member 12 rotates, for example, 90°, the link 13 comes into line contact with the inner peripheral surface 39a of the opening part 39 of the rotary coupling member 12. In this event, the posture of the link 13 with respect to the rotary coupling member 12 stabilizes, whereby the rotation of the rotary coupling member 12 and the link 13 stops.

Note that there also is a case where a force K inclined 450 upward with respect to the x-direction in FIG. 9(a) acts on the semicircular arc part 13a of the link 13 with the straight part 13d of the link 13 being inserted into the opening part 39 of the rotary coupling member 12.

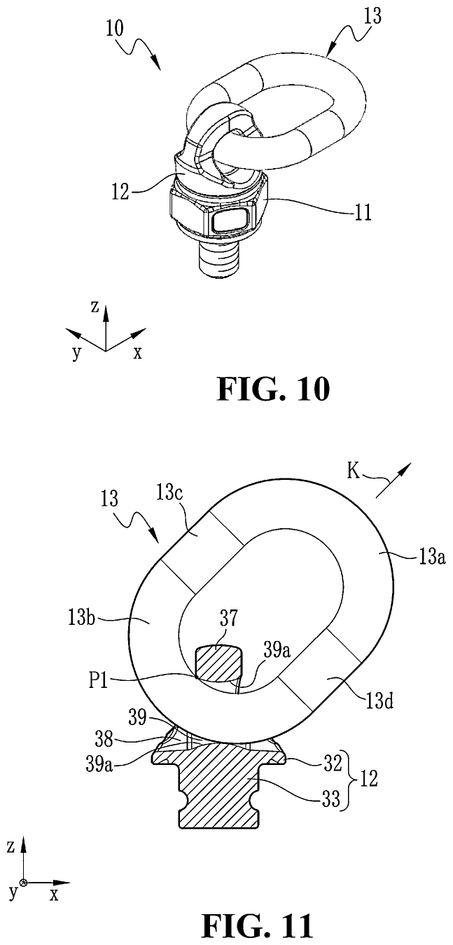

In this case, the force K acts on the link 13 as illustrated in FIG. 11, so that the link 13 takes a posture in which the semicircular arc part 13a is located obliquely 450 upward with respect to the semicircular arc part 13b. In this state, the semicircular arc part 13a of the link 13 and the curved surface 47 are brought into contact with each other (the point P1 indicates the contact position), and the posture of the link 13 with respect to the rotary coupling member 12 in this case is also in an unstable state.

In this event, if a force acting in either the y-direction or the −y-direction is applied on the link 13, the link moves in either the y-direction or the −y-direction. As a result, the link 13 changes from the state where the semicircular arc part 13a of the link 13 and the curved surface 47 are in contact with each other to either a state where the semicircular arc part 13a of the link 13 and the curved surface 45 are in contact with each other or a state where the semicircular arc part 13a of the link 13 and the curved surface 46 are in contact with each other. In response to this, the rotary coupling member 12 rotates in the E1 direction or the E2 direction, and the rotary coupling member 12 rotates. Then, once the rotary coupling member 12 rotates, for example, 90°, the link 13 comes into line contact with the inner peripheral surface 39a of the opening part 39 of the rotary coupling member 12, resulting in that the posture of the link 13 with respect to the rotary coupling member 12 stabilizes.

As explained above, the hanging fitting 10 in this embodiment is a hanging fitting 10 to be fixed to the mounting surface of the cargo and used in the cargo lifting work, and includes the rotary coupling member 12 which rotates around the direction orthogonal to the mounting surface of the cargo, and the link 13 which is coupled with the rotary coupling member 12 and to which a hung member is locked in the cargo lifting work, in which the rotary coupling member 12 has the main body part 32, the beam part 37 provided at an upper part of the main body part 32, and the opening part 39 which is provided between the beam part 37 and the main body part 32 and into which the link 13 to be coupled with the rotary coupling member 12 is inserted, and the width of the middle portion of the beam part 37 is wider than the widths at the both end portions.

In the above configuration, for example, the link 13 is kept in contact with the rotary coupling member 12 at the point P1 and the point P2 in the posture where the link 13 is located in a direction in which the longitudinal direction of the link 13 is orthogonal to the rotation axis direction of the rotary coupling member 12 as illustrated in FIG. 9. If the positional relationship between the link 13 and the rotary coupling member 12 is not changed while keeping the state, the link 13 is located in a very unstable state.

For example, when a plurality of hanging fittings are mounted on a cargo and the lifting work is performed by one crane using the plurality of hanging fittings, if there is even one hanging fitting in which the link is located in an unstable state, the force does not evenly acts on the plurality of hanging fittings when lifting the cargo, and the wire and the chain lifting the cargo may be damaged, which is dangerous.

In contrast to the above, in the hanging fitting 10 explained in the above embodiment, the side surfaces 41, 42 of the beam part 37 each have at least two flat surfaces combined while being folded outward so that the width of the beam part 37 at the middle portion in the extending direction is wider than the widths at the both end portions in plan view of the rotary coupling member 12. Therefore, when a force acts on the link 13 engaged with the rotary coupling member 12, the link 13 moves toward either one of both end portions in the longitudinal direction of the beam part 37 to rotate the rotary coupling member 12. This rotation can change the posture of the link 13 with respect to the rotary coupling member 12 into the state where the longitudinal direction of the link 13 becomes parallel to the extending direction of the beam part 37 of the rotary coupling member 12 (see FIG. 10). This state is a state where the link 13 is in line contact with the beam part 37 of the rotary coupling member 12. Accordingly, the posture of the link 13 with respect to the rotary coupling member 12 stabilizes. As a result, the force evenly acts on the plurality of hanging fittings, thus making it possible to prevent breakage of the wire and the chain lifting the cargo.

Further, the link 13 moves toward either one of both end portions in the longitudinal direction of the beam part 37, and therefore the moving direction of the link 13 is not limited to one direction depending on the force acting on the link 13. In other words, the link 13 can move in two directions such as the y-direction and the −y-direction in FIG. 4 according to the force acting on the link 13. As a result, the degree of wear of the link 13 and the beam part 37 becomes equal in the extending direction of the beam part 37, thus providing an operation and effect capable of extending the service life of the hanging fitting 10 itself.

Further, the opening part 39 is provided so that the center axis of the opening part 39 is orthogonal to the rotation axis of the rotary coupling member 12.

In the case of pulling the link 13 coupled with the rotary coupling member 12 upward, the force in the vertical direction acting on the link 13 becomes smaller as the center axis of the opening part 39 is further away from the rotation axis of the rotary coupling member 12. On the other hand, in a state where the center axis of the opening part 39 is orthogonal to the rotation axis of the rotary coupling member 12, the force in the vertical direction acting on the link 13 become largest. Accordingly, making the center axis of the opening part 39 orthogonal to the rotation axis of the rotary coupling member 12 can maximize the use of the force acting on the link 13 when pulling the link 13 upward. Further, in the case where the opening part 39 is provided such that the center axis of the opening part 39 is orthogonal to the rotation axis of the rotary coupling member 12, the load acting on the link 13 can be reduced as compared with the case where the opening part 39 is provided such that the center axis of the opening part 39 is not orthogonal to the rotation axis of the rotary coupling member 12.

Further, the link 13 is the bar member in an elliptical shape having the two semicircular arc parts 13a, 13b and the two straight parts 13c, 13d linking the two semicircular arc parts 13a, 13b, and the diameter of the opening part 39 is larger than the diameter of the bar member and smaller than the maximum radius of the semicircular arc parts 13a, 13b of the link 13.

According to this configuration, for example, in the state where the link 13 is in contact with the beam part 37 of the rotary coupling member 12, the posture of the link 13 with respect to the rotary coupling member 12 is likely to be an unstable posture. In this state, even if a slight force in a direction different from the pulling force merely acts on the link 13 when the link 13 is pulled, the rotary coupling member 12 can rotate in its axial direction to correct the posture of the link 13 to a stable posture.

The anchor fitting 11 is provided which pivotally supports the rotary coupling member 12 and has the male threaded part 21 to be screwed into the female threaded portion provided at the mounting surface of the cargo.

According to this configuration, with the male threaded part 21 being screwed into the female threaded hole of the cargo to fix the anchor fitting 11 to the cargo, the rotary coupling member 12 can be freely rotated according to the direction of the force acting on the link 13 with respect to the anchor fitting 11. Further, when the beam part 37 of the rotary coupling member 12 is worn, not the whole hanging fitting 10 is replaced but only the rotary coupling member 12 and the link 13 engaging with the rotary coupling member 12 only need to be replaced.

Note that the link having the two semicircular arc parts and the two straight parts linking the semicircular arc parts is an example in the above embodiment, but a link in a shape in which two arcs different in size are combined, and links in a circular shape and oval shape without straight parts may be used. Further, such a link may be used that has a shape in which two straight parts extending in one direction and two straight parts extending in a direction orthogonal to the one direction are arranged in a frame shape and those straight parts are linked by circular arc portions arranged at four corners. In other words, the shape only need to be the one that can engage the link and the rotary coupling member with each other with a moderate degree of freedom by inserting a part of the closed link into the opening part 39 of the rotary coupling member 12. Even in the case of this link, the diameter of the opening part 39 of the rotary coupling member 12 is made larger than the diameter of the bar member constituting the link and smaller than the maximum outer diameter of the circular arc portion of the link, thereby making it possible to provide the same effect as in the above embodiment.

In the above embodiment, the side surfaces 41, 42 of the beam part 37 of the rotary coupling member are configured such that the width of the beam part at the midpoint in the extending direction is wider than the widths at both end portions. As its one example, the case where the side surfaces 41, 42 of the beam part 37 are side surfaces each having at least two flat surfaces combined while being folded outward is explained. However, the side surface of the beam part may be a curved surface curved so that the width of the beam part at the middle portion is wider than the widths at both end portions instead of combining the two flat surfaces to constitute the side surface. Further, the side surface may be constituted by combining two or more curved surfaces. In this case, as the two curves surfaces, either a concave curved surface or a convex curved surface can be used. Note that a boundary portion between the two curved surfaces is preferably linear as much as possible.

In the above embodiment, the position where the two flat surfaces 41a, 41b constituting one side surface 41 of the beam part 37 are folded and the position where the two flat surfaces 42a, 42b constituting the other side surface 42 are folded, that is, the positions of the vertexes of the side surfaces 41, 42 are at the midpoint in the extending direction of the beam part 37 (y-direction in FIG. 4(a)). Accordingly, when the force J in the x-direction in FIG. 9(c) acts on the semicircular arc part 13a of the link 13 in the state where the straight part 13d of the link 13 is inserted into the opening part 39 of the rotary coupling member 12, in other words, in the state where the longitudinal direction of the link 13 is orthogonal to the rotation axis direction of the rotary coupling member 12 as illustrated in FIG. 9(c), the semicircular arc part 13b of the link 13 sometimes stabilizes in a state of being in contact with the curved surface 47 provided on the lower surface of the beam part 37 and the inner peripheral surface 39a of the opening part 39 (points P1, P2 in FIG. 9(b)). In the case of lifting the cargo in this state, the posture of the link 13 with respect to the rotary coupling member 12 is stable, but an excessive load acts on the hanging fitting 10 when lifting, which is dangerous.

Hence, the vertexes of the two side surfaces of the beam part of the rotary coupling member are not arranged at the midpoint in the extending direction of the beam part but can be arranged at positions shifted from the midpoint. Hereinafter, the configuration of the link will be explained with the same reference signs to those in the above embodiment.

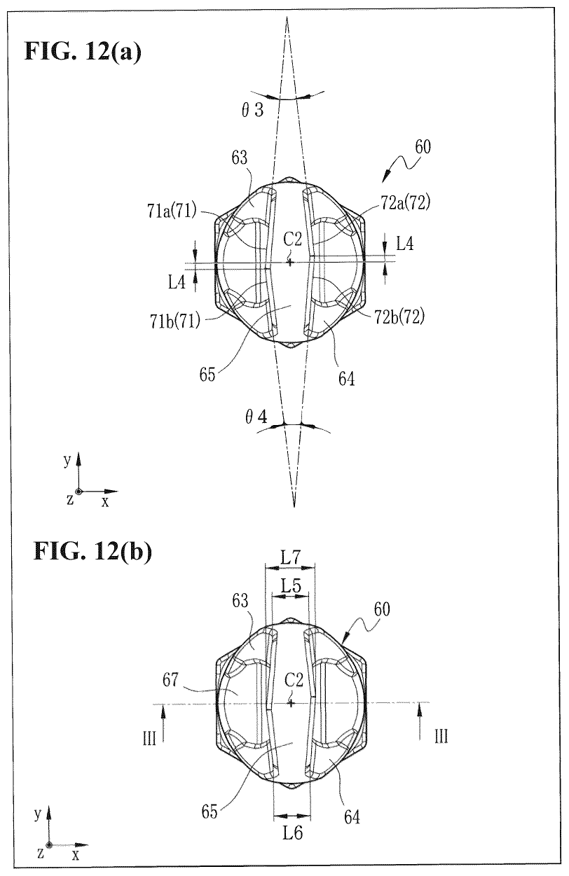

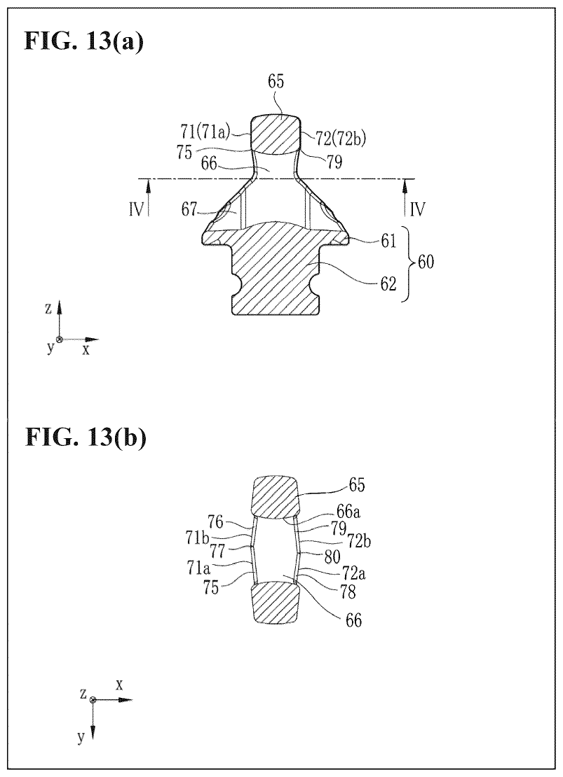

As illustrated in FIG. 12 and FIG. 13, a rotary coupling member 60 has a main body part 61 and a rotary shaft part 62. The main body part 61 has, for example, two raised parts 63, 64 provided at an interval of 180° on an upper surface of the disk-shaped main body part 61 in plan view of the rotary coupling member 60, and an arched beam part 65 arranged across the two raised parts 63, 64. By arranging the beam part 65 across the two raised parts 63, 64, the main body part 61 has an opening part 66 surrounded by them. Between the two raised parts 63, 64, a recessed part (groove portion) 67 is provided in a direction orthogonal to the extending direction of the beam part 65. The recessed part 67 is provided continuously to the opening part 66 provided below the beam part 65.

The beam part 65 has two side surfaces 71, 72. One side surface 71 has such a shape that two flat surfaces 71a, 71b are joined while being folded into a projecting shape toward an outer peripheral edge of the main body part 61 in top view of the rotary coupling member 60. The position where the two flat surfaces 71a, 71b constituting the side surface 71 are folded, in other words, the position of the vertex of the side surface 71 is set at a position obtained by shifting it by a distance L4 in a −y-direction in FIG. 12(a) from the midpoint in the extending direction of the beam part 65 (namely, an axial center C2 of the rotary coupling member 60).

The other side surface 72 has such a shape that two flat surfaces 72a, 72b are joined while being folded into a projecting shape toward an outer peripheral edge of the main body part 61 in top view of the rotary coupling member 60. The position where the two flat surfaces 72a, 72b constituting the other side surface 72 are folded, in other words, the position of the vertex of the side surface 72 is set at a position obtained by shifting the distance L4 in a y-direction in FIG. 12(a) from the midpoint in the extending direction of the beam part 65 (namely, the axial center C2 of the rotary coupling member 60). Note that the distance L4 is set to a range of 1/10 to ¼ of the diameter of the link 13 locked to the rotary coupling member 60. In this case, as illustrated in FIG. 12(b), widths L5, L6 (L5=L6) at both end portions of the beam part 65 are smaller than a maximum width L7 near the middle of the beam part 65. In this case, as illustrated in FIG. 12(a), an angle θ3 formed between the flat surface 71a and the flat surface 72a and an angle θ4 formed between the flat surface 71b and the flat surface 72b are the same and set in detail as follows.

For example, if the above angle θ3 and angle θ4 are increased, when the link 13 moves to either one end portion of both end portions in the extending direction of the beam part 37, a movement amount of the link 13 decreases and the link 13 is likely to bite into a gap generated between the beam part 65 and the raised part (either the raised part 63 or the raised part 64) of the rotary coupling member 60 located on the side to which the link 13 moves. As a result of this, the rotary coupling member 12 does not rotate to a state where the posture of the link 13 with respect to the rotary coupling member 12 stabilizes (see later-explained FIG. 10), but possibly stops rotating in the middle of the rotation. In this state, the posture of the link 13 with respect to the rotary coupling member 60 is unstable, and when a force different from a force acting in a direction in which the cargo is hung on the hanging fitting 10 acts to eliminate the bite of the link 13 into the gap, the rotary coupling member 60 rotates to a state where the posture of the link 13 with respect to the rotary coupling member 12 stabilizes, which is dangerous.

On the other hand, if the angle θ3 and angle θ4 are too small, a force acting when moving the link 13 to either one end portion of both end portions in the extending direction of the beam part 65 is small, and therefore it is necessary to pull the link 13 by a large force more than necessary to rotate the rotary coupling member 12 until the posture of the link 13 with respect to the rotary coupling member 60 is brought into a stabilized state (see later-explained FIG. 10).

Accordingly, in consideration of the movement amount of the link 13 when the link 13 moves to either one end portion of both end portions in the extending direction of the beam part 65 and the securement of a force acting when moving the link 13 to either one end portion of both end portions in the extending direction of the beam part 65, the angle θ3 and the angle θ4 are preferably in a range of, for example, 5 to 25°, and preferably in a range of, for example, 10 to 15°.

Further, also in this case, the beam part 65 is subjected to R chamfering.

Accordingly, as illustrated in FIG. 13(a) and FIG. 13(b), a curved surface 75 is formed between the flat surface 71a of the beam part 65 and an inner peripheral surface 66a of the opening part 66. Further, a curved surface 76 is formed between the flat surface 71b of the beam part 65 and the inner peripheral surface 66a of the opening part 66.

Between the curved surfaces 75 and 76, a curved surface 77 is formed which continues to the curved surfaces 75, 76.

Similarly, a curved surface 78 is formed between the flat surface 72a of the beam part 65 and the inner peripheral surface 66a of the opening part 66. Further, a curved surface 79 is formed between the flat surface 72b of the beam part 65 and the inner peripheral surface 66a of the opening part 66. Between the curved surfaces 78 and 79, a curved surface 80 is formed which continues to the curved surfaces 78, 79.

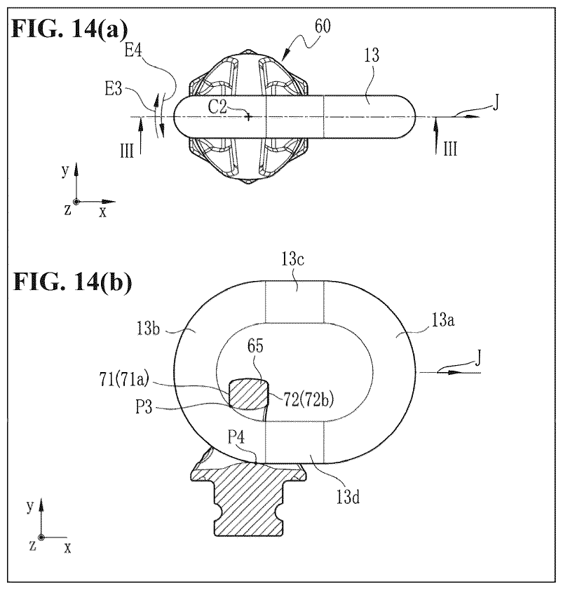

In this case, when a force J in an x-direction in FIG. 14(a) acts on the semicircular arc part 13a of the link 13 in the state where the semicircular arc part 13b of the link 13 is inserted into the opening part 66 of the rotary coupling member 60 and the longitudinal direction of the link 13 is orthogonal to the extending direction of the beam part 65 of the rotary coupling member 60 and to the rotation axis direction of the rotary coupling member 60 as illustrated in FIG. 14(a) and FIG. 14(b), the link 13 is held in a state where the inner peripheral surface of the semicircular arc part 13a of the link 13 is in contact with the curved surface 75 between the side surface 71 of the beam part 65 and the inner peripheral surface 66a of the opening part 66, namely, at a point P3 illustrated in FIG. 14(b), and the outer peripheral surface of the semicircular arc part 13b of the link 13 is in contact with the inner peripheral surface 66a of the opening part 66 of the rotary coupling member 60 at a point P4 illustrated in FIG. 14(b).

Here, the side surface 71 of the beam part 65 has the vertex at a position obtained by shifting by the distance L4 in the −y-direction in FIG. 12(a) from the midpoint in the extending direction of the beam part 65. Besides, the side surface 72 of the beam part 65 has the vertex at a position obtained by shifting by the distance L4 in the y-direction in FIG. 12(a) from the midpoint in the extending direction of the beam part 65. Accordingly, when the force J in the x-direction in FIG. 14(a) acts on the semicircular arc part 13a of the link 13, the link 13 is in contact with the rotary coupling member 60 at the two points P3, P4, and when the force J in the x-direction acts on the link 13, a force perpendicular to the curved surface 75 of the force J in the x-direction acts on the curved surface 75, with which the link 13 comes into contact, between the flat surface 71a of the rotary coupling member 60 and the inner peripheral surface 66a of the opening part 66. Accordingly, when the force J in the x-direction acts on the link 13, the rotary coupling member 60 rotates in an E3 direction in FIG. 14(a). This rotation can change the posture of the link 13 with respect to the rotary coupling member 12 to a state where the longitudinal direction of the link 13 is parallel to the extending direction of the beam part 65 of the rotary coupling member 60.

Note that when a force in a −x-direction acts on the link 13, a force perpendicular to the curved surface 79 of the force J in the x-direction acts on the curved surface 79, with which the link 13 comes into contact, between the flat surface 72a of the rotary coupling member 60 and the inner peripheral surface 66a of the opening part 66, and the rotary coupling member 60 rotates in an E4 direction in FIG. 14. In the case where the side surfaces 71, 72 of the beam part 65 are side surface each having two flat surfaces folded as above, the same effect can be obtained even if the vertex of the two flat surfaces is shifted from the midpoint in the extending direction of the beam part, as in the case where the vertex is arranged at the midpoint.

The above-explained hanging fitting 10 has such a structure that a hook of a crane, a wire rope, or a shackle coupled with the hook of the crane is engaged with the link 13 which is engaged with the beam part 37 of the rotary coupling member 12, but may be a hanging fitting in which the link 13 is not engaged with the beam part 37 of the rotary coupling member 12. In this case, the hook of the crane, the wire rope, or the shackle coupled with the hook of the crane is directly engaged with the beam part 37 of the rotary coupling member 12. Besides, the hanging fitting using not the rotary coupling member 12 but the rotary coupling member 60 may be similarly a hanging fitting in which the link 13 is not engaged with the arched beam part 65 of the rotary coupling member 60.

In the above-explained hanging fitting 10, the rotary shaft part 33 provided at the rotary coupling member 12 is inserted into the insertion space 24 of the fitting coupling part 23 of the anchor fitting 11, whereby the rotary coupling member 12 is rotatably held with respect to the anchor fitting 11. In contrast to this, for example, an insertion hole may be provided in the rotary coupling member and a rotary shaft part may be provided at an upper surface of the pedestal portion of the anchor fitting, and the rotary shaft part of the anchor fitting may be inserted into the insertion hole of the rotary coupling member to rotatably hold the rotary coupling member with respect to the anchor fitting.

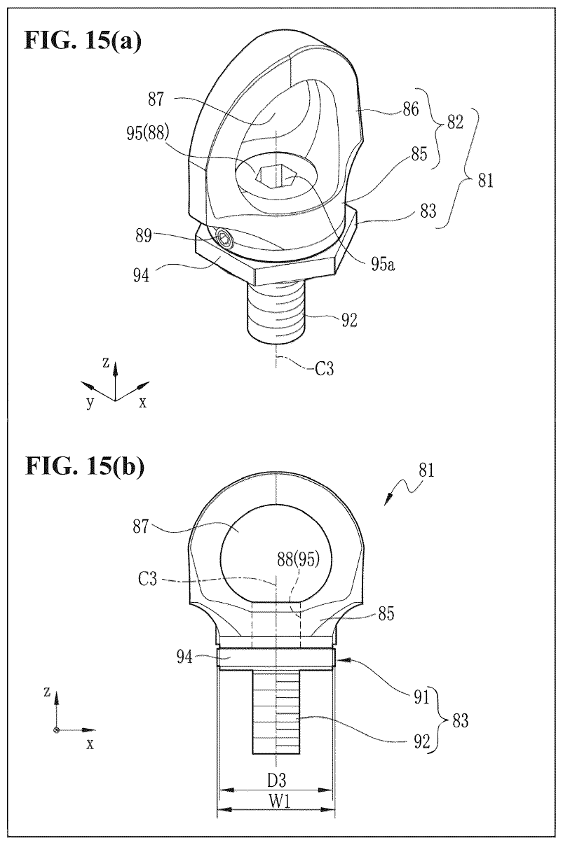

For example, as illustrated in FIG. 15(a) and FIG. 15(b), a hanging fitting 81 has a rotary coupling member 82 and an anchor fitting 83. The rotary coupling member 82 has a main body part 85, and an arched beam part 86 provided at an upper part of the main body part 85, and an opening part 87 is formed between the main body part 85 and the beam part 86 by joining both end portions in the extending direction of the beam part 86 to the main body part 85. In side view of the rotary coupling member 82 (in xz-plan view in FIG. 15(b)), a portion where both end portions in the extending direction of the beam part 86 and the main body part 85 are joined is curved toward a center axis of the anchor fitting 83 (in more detail, a center axis C3 of a male threaded part 92 of the anchor fitting 83). Further, the main body part 85 is provided with an insertion hole 88 from the upper surface to the lower surface, into which a later-explained rotary shaft part 95 is inserted. Here, the outer shape of the lower surface of the main body part 85 is, for example, a circular shape.

The anchor fitting 83 has a rotary coupling part 91, and a male threaded part 92 extending to the rotary coupling part 91. The rotary coupling part 91 of the anchor fitting 83 has a pedestal part 94 in a hexagonal shape, and a rotary shaft part 95 projecting upward from the upper surface of the pedestal part 94 and inserted into the insertion hole 88 of the rotary coupling member 82. Though not illustrated, recessed portions are provided on the inner peripheral surface of the rotary coupling member 82 facing the insertion hole 88 and on the outer peripheral surface of the rotary shaft part 95 so that the recessed portions form a doughnut-shaped space when the rotary shaft part 95 is inserted into the insertion hole 88 of the rotary coupling member 82. Further, the rotary coupling member 82 is provided with a threaded hole (not illustrated) formed toward the inner peripheral surface facing the insertion hole 88, and a plurality of bearing balls are inserted into the space through the threaded hole. Thus, the rotary coupling member 82 is rotatably coupled with the anchor fitting 83. Note that the threaded hole is sealed with a hexagonal screw 89.

The rotary shaft part 95 is provided with a hexagonal hole 95a on the upper surface of the rotary shaft part 95. Into the hexagonal hole 95a, for example, a not-illustrated hexagonal wrench is inserted and the hexagonal wrench is rotated around the center axis C3 of the male threaded part 92, thereby making it possible to fasten or loosen the anchor fitting 83 to/from the cargo.

As explained above, the outer shape of the lower surface of the main body part 85 of the rotary coupling member 82 is a circular shape. Besides, the pedestal part 94 of the anchor fitting 83 is in a hexagonal prismatic shape. In this case, for example, the outer shape of the upper surface of the pedestal part 94 is larger than the outer shape of the lower surface of the main body part 85. Mores specifically, assuming that the diameter of the lower surface of the main body part 85 is D3 and the minimum width of the pedestal part 94 is W1, the minimum width W1 of the pedestal part 94 is larger than the diameter D3 of the lower surface of the main body part 85. Further, as explained above, the rotary coupling member 82 is curved toward the center axis of the anchor fitting 83 (in more detail, the center axis C3 of the male threaded part 92 of the anchor fitting 83) at a joint portion between both end portions of the beam part 86 and the main body part 85. Accordingly, in the case where the operator performs a work of fastening the hanging fitting 81 to the cargo by hands, the pedestal part 94 is easily grasped. Further, it becomes easier to perform the work of fastening the male threaded part 92 of the anchor fitting 83 to the female threaded portion of the cargo to some extent or rotating the anchor fitting 83 loosed to some extent to remove it from the cargo, with the operator grasping the pedestal part 94 by hands. It also becomes easier to insert the pedestal part 94 into a mouth (bore) of the wrench, thereby facilitating the work of fastening the hanging fitting to the cargo and the work of removing the hanging fitting from the cargo.

Note that in the hanging fitting 10 illustrated in the above-explained embodiment, the two flat surfaces 41a, 41b are folded so that the extending direction of a ridgeline provided between the two flat surfaces 41a and 41b constituting the side surface 41 of the beam part 37 is parallel to the z-direction in FIG. 1 and the side surface 41 of the beam part 37 is formed in such a shape that the midpoint in the extending direction of the beam part 37 is projected outward. However, the extending direction of the ridgeline does not need to be parallel to the z-direction in FIG. 1 and, for example, it is possible to fold the two flat surfaces 41a, 41b outward so that the extending direction of the ridgeline is included in either a yz-plane or an xz-plane and is a direction inclined at a predetermined angle with respect to the z-direction in FIG. 1. In this case, the side surface 41 only needs to project outward at the midpoint in the extending direction of the beam part 37 or at a position shifted by a predetermined amount from the midpoint.

Though not explained, the side surface 42 of the beam part 37 has the same configuration as that of the side surface 41 of the beam part 37 or may have a different configuration.

### REFERENCE SIGNS LIST

10 . . . hanging fitting
11 . . . anchor fitting
12, 60 . . . rotary coupling member
13 . . . link
32, 61 . . . main body part
37, 65 . . . beam part
39, 66 . . . opening part
39a, 66a . . . inner peripheral surface
41, 42, 71, 72 . . . side surface
45, 46, 47, 48, 49, 50, 75, 76, 77, 78, 79, 80 . . . curved surface

1. A hanging fitting to be fixed to a mounting surface of a cargo and used in a hanging work of the cargo, the hanging fitting comprising:
a rotary coupling member which rotates around a direction orthogonal to the mounting surface of the cargo; and
an anchor fitting which has a male threaded part to be screwed into a female threaded portion provided at the mounting surface of the cargo, and pivotally supports the rotary coupling member,
the rotary coupling member including:
a main body part;
an arched beam part provided at an upper part of the main body part; and
an opening part formed by providing the beam part at an upper part of the main body part,
at least a part of at least either one side surface of two side surfaces in a width direction of the beam part having a shape projecting outward at a midpoint of the beam part in an extending direction of the beam part or at a position shifted by a predetermined amount from the midpoint to the extending direction in plan view of the rotary coupling member.

2. The hanging fitting according to claim 1, wherein:
the side surface is constructed by joining at least two flat surfaces folded outward; and
a vertex of the side surface is arranged on a straight line passing through the midpoint in the extending direction of the beam part and extending in a direction orthogonal to the extending direction of the beam part, in plan view of the rotary coupling member.

3. The hanging fitting according to claim 1, wherein:
the side surface is constructed by joining at least two flat surfaces folded outward; and
a vertex of the side surface is arranged at a position shifted by a predetermined amount to either one end portion side of both end portions of the beam part from the midpoint in the extending direction of the beam part, in plan view of the rotary coupling member.

4. The hanging fitting according to claim 1, wherein
the opening part is provided such that a center axis of the opening part is orthogonal to a rotation axis of the rotary coupling member.

5. The hanging fitting according to claim 1, wherein
a link to be engaged with the rotary coupling member is inserted into the opening part.

6. The hanging fitting according to claim 5, wherein:
the link is made by bending a bar member into an elliptical shape having two semicircular arc parts and two straight parts linking the two semicircular arc parts; and
a diameter of the opening part is larger than a diameter of the bar member and smaller than a maximum radius of the two semicircular arc parts provided at the link.

7. The hanging fitting according to claim 1, wherein:
the anchor fitting has a fitting coupling part which rotatably couples the rotary coupling member; and
an outer shape of an upper surface of the fitting coupling part is larger than an outer shape of a lower surface of the main body part.
